(19) United States
(12) Patent Application Publication
(10) Pub. No.: US 2017/0251547 A1
(43) Pub. Date: Aug. 31, 2017

(54) TARGET DEVICE, RADIONUCLIDE PRODUCING APPARATUS AND METHOD OF PRODUCING A RADIONUCLIDE

(71) Applicant: Nihon Medi-Physics Co., Ltd., Tokyo (JP)

(72) Inventor: Taku ITO, Tokyo (JP)

(73) Assignee: Nihon Medi-Physics Co., Ltd., Tokyo (JP)

(21) Appl. No.: 15/437,145

(22) Filed: Feb. 20, 2017

(30) Foreign Application Priority Data
Feb. 29, 2016 (JP) 2016-037710

(51) Int. Cl. H05H 6/00; G21G 1/04

(52) U.S. Cl. CPC H05H 6/00; G21G 1/04

(57) ABSTRACT

Disclosed is a target device (10) having a plurality of target material plates (20a, 20b) for producing a radionuclide, lined up in an overlapped manner, configured to produce the radionuclide when a particle beam is irradiated on the target material plates (20a, 20b), the target device (10) having a front plate group (GRF) composed of target material plates (20a) positioned to the front side the particle beam comes in, and a rear plate group (GRR) composed of the target material plates (20b) positioned to the rear side, and the average thickness of the target material plates (20a) composing the front plate group (GRF) being smaller than the average thickness of the target material plates (20b) composing the rear plate group (GRR).

This application is based on Japanese patent application No. 2016-037710, filed on Feb. 29, 2016, the content of which is incorporated hereinto by reference.

### BACKGROUND

Technical Field

This invention relates to a target device used for producing radionuclides, and a radionuclide producing apparatus.

Related Art

Single photon emission computed tomography (SPECT) and positron emission tomography (PET) have been known as nuclear medical imaging techniques. According to SPECT and PET, a radiopharmaceutical, that is a radionuclide-labeled compound, is administered to a subject, and emitted gamma ray is captured by a camera for imaging. Technetium 99m (^{99m}Tc) is one example of a variety of radionuclides used for the radiopharmaceutical. Metastable technetium 99m emits a gamma ray when it falls to the ground state to become technetium 99. By virtue of its half-life as short as approximately 6 hours, the nuclide advantageously suppresses the radiation dose to the subject.

Technetium 99m is a daughter nuclide resulted from the beta decay of molybdenum 99 (⁹⁹Mo), and thus molybdenum 99 has been used as a source of radiopharmaceuticals that employ technetium 99m.

Molybdenum 99 has been produced by several methods, including not only a commercially practiced method of causing nuclear fission of uranium 235 in a nuclear reactor under neutron irradiation, but also an alternative method of irradiating molybdenum 100 with a particle beam such as neutron or proton accelerated by a particle accelerator. In particular, the latter method based on irradiation of particle beam, with no need of using a nuclear reactor, has attracted public attention since it is free from reactor accident and is able to produce radionuclides stably long for the future.

As a technique of producing a radionuclide based on particle beam irradiation, International Publication WO2014/186898 pamphlet describes a method of producing radionuclide by irradiating a material, called converter, for producing bremsstrahlung (photon) with electrons having been accelerated by an electron beam particle accelerator, and allowing the bremsstrahlung to collide on molybdenum 100 to produce a radionuclide. The converter is made of a heavy metal element such as tantalum. The reaction, allowing a gamma (γ) ray such as photon to collide on a target material such as molybdenum 100 for producing radionuclide, and thus obtaining neutron as well as intended radionuclide such as molybdenum 99, is simply denoted as (γ,n) reaction, and more specifically symbolized by ¹⁰⁰M(γ,n)⁹⁹Mo. International Publication WO2014/186898 pamphlet also describes that a large number of target disks of molybdenum 100 are arranged while keeping a space in between, which are collectively held by a holder for the convenience of irradiation. The space is fed with cooling water, in order to cool the target disks that are heated under collision with electrons and photons.

Also JP-A-2015-99117 and JP-T2-H10-508950 disclose similar methods of producing radionuclide (molybdenum 99), in such a way that bremsstrahlung is obtained by irradiating the converter with electrons having been accelerated by an electron beam accelerator, and then a target material such as molybdenum 100 is irradiated with bremsstrahlung to thereby cause the (γ,n) reaction. JP-T2-H10-508950 discloses that a target material is configured by alternately disposing a plural number of sets (six sets, for example) of molybdenum foil and molybdenum plate, both having been sliced from a cylindrical ingot of molybdenum 100. By interposing the molybdenum foil between the molybdenum plates, it is reportedly possible to quantify the degree of activity of technetium 99 at every depth of the foil.

In order to produce a large amount of radionuclide such as molybdenum 99, it is effective to increase the amount of target material, and to increase the output of beam from the electron beam accelerator. An increased output of beam, however, makes the thermal control difficult due to increased amount of heat production in the target material, which may sometimes result in fusing of the target material.

On the contrary, from the viewpoint of commercial production of radionuclide, it has been required to reduce the amount of consumption of the target material used as a source. This is because the target material for producing radionuclide is made of an expensive high-purity source obtained by enrichment of a desired stable isotope only, for the purpose of minimizing contamination of impurity nuclides produced as by-products during nuclear reaction. Even if the target material is intended for recycling, a certain material loss will occur for every run of beam irradiation, so that the larger the target material, the lower the efficiency of utilization will be, and therefore the larger the economic loss will be. Size-up of the target material also raises a need of large-scale chemical post-processing for extracting the resultant radionuclide, further increasing the cost of process.

As has been described above, in the production of radionuclide, there are contradictory requirements for increasing and decreasing the amount of consumption of target material used for every single run of beam irradiation.

### SUMMARY

This invention is proposed after contemplating the problems described above, and is to provide a target device that is capable of efficiently producing intended radionuclide with a minimum consumption of target material, while considering the need of moderating the thermal load given by the particle beam; and is to provide a radionuclide producing apparatus equipped with such target device.

According to this invention, there is provided a target device that includes a plurality of target material plates for producing a radionuclide that are lined up in an overlapped manner, configured to produce the radionuclide when a particle beam is irradiated on the target material plates,

the plurality of target material plates being grouped into a front plate group composed of a part of the target material plates positioned to the front side the particle beam comes in, and a rear plate group composed of the residual part of the target material plates positioned to the rear side that is opposite to the front side, and the diameter or average thickness of the target material plates composing the front plate group being smaller than the diameter or average thickness of the target material plates composing the rear plate group.

According to this invention, there is also provided a radionuclide producing apparatus which includes the target device described above; a particle accelerator that produces the particle beam; and an extraction unit that extracts, from the target device, the radionuclide produced when the particle beam is irradiated on the target material plates.

### BRIEF DESCRIPTION OF THE DRAWINGS

The above and other objects, advantages and features of this invention will be more apparent from the following description of certain preferred embodiments taken in conjunction with the accompanying drawings, in which:

FIG. 1A is a schematic cross-sectional view illustrating a target device of a first embodiment, and FIG. 1B is a schematic front elevation of the target material plate;

FIG. 2 is a configuration chart illustrating a radionuclide producing apparatus equipped with the target device;

FIG. 3A is a schematic side elevation illustrating an arrangement of the target material plates of a second embodiment, and FIG. 3B is a schematic side elevation illustrating an arrangement of the target material plates according to a modified example of the second embodiment;

FIG. 4A is a schematic side elevation illustrating an arrangement of the target material plates of a third embodiment, and FIG. 4B is a schematic side elevation illustrating an arrangement of the target material plate according to a modified example of the third embodiment;

FIG. 5 is an image illustrating a fluence distribution of bremsstrahlung photons over the target material plates in Example 1;

FIG. 6 is a contrast-changed version of FIG. 5;

FIG. 7 is an image illustrating a fluence distribution of bremsstrahlung photons over the target material plates in Example 2;

FIG. 8 is a contrast-changed version of FIG. 7;

FIG. 9 is an image illustrating a fluence distribution of bremsstrahlung photons over the target material plates in Example 3;

FIG. 10 is a contrast-changed version of FIG. 9;

FIG. 11 is an image illustrating a fluence distribution of bremsstrahlung photons over the target material plates in Comparative Example 1;

FIG. 12 is a contrast-changed version of FIG. 11;

FIG. 13 is an image illustrating a fluence distribution of bremsstrahlung photons over the target material plates in Example 4;

FIG. 14 is a contrast-changed version of FIG. 13;

FIG. 15 is an image illustrating a fluence distribution of bremsstrahlung photons over the target material plates in Example 5;

FIG. 16 is a contrast-changed version of FIG. 15;

FIG. 17 is an image illustrating a fluence distribution of bremsstrahlung photons over the target material plates in Comparative Example 2;

FIG. 18 is a contrast-changed version of FIG. 17; and

FIG. 19 is a graph illustrating ⁹⁹Mo yield from the individual target material plates in Example 6.

### DETAILED DESCRIPTION

The invention will be now described herein with reference to illustrative embodiments. Those skilled in the art will recognize that many alternative embodiments can be accomplished using the teachings of this invention and that the invention is not limited to the embodiments illustrated for explanatory purposes.

Embodiments of this invention will be explained below referring to the attached drawings. Note that, in all drawings, all similar constituents will have same reference numerals or symbols, in order to properly avoid repetitive descriptions.

### First Embodiment

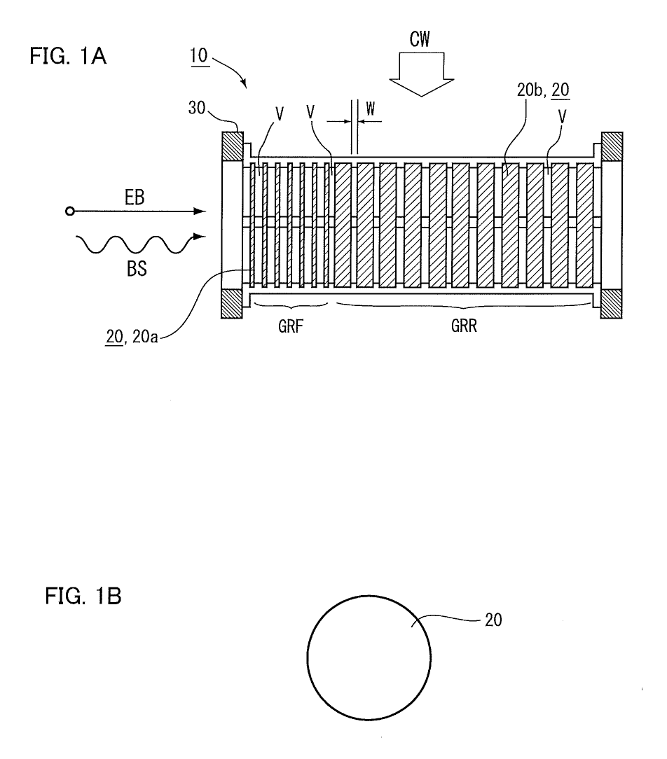

FIG. 1A is a schematic cross-sectional view illustrating a target device 10 of a first embodiment, and FIG. 1B is a schematic front elevation of a target material plate 20, showing a plan-view shape viewed from the direction of particle beam irradiation.

The target device 10 of this embodiment has a plurality of target material plates 20 (20a, 20b) for producing a radionuclide which are lined up in an overlapped manner, and is configured to produce the radionuclide when a particle beam is irradiated on the target material plates 20. A part of the plurality of target material plates 20 may occasionally be referred to as the “target material plates 20a or 20b”, hereinafter.

The target device 10 has a front plate group GRF composed of a plurality of target material plates 20a positioned to the front side the particle beam comes in, and a rear plate group composed of a plurality of target material plates 20b positioned to the rear side that is opposite to the front side.

The target device 10 of this embodiment is characterized in that the average thickness of the target material plates 20a composing the front plate group GRF is smaller than the average thickness of the target material plate 20b composing the rear plate group GRR.

In one modified example of this embodiment, the intended effect will be obtained also by making the diameter of the target material plates 20a composing the front plate group GRF smaller than the diameter of the target material plates 20b composing the rear plate group GRR. Such embodiment will be explained later referring to Third Embodiment.

Next, the target device 10 and a radionuclide producing apparatus 100 will be detailed.

The target device 10 includes a plurality of target material plates 20 that are made of a source material selected to produce a desired radionuclide (occasionally referred to as “target substance”, hereinafter), and a holding frame 30 that holds the target material plates 20 arranged in line. Each of the target material plates 20 is a sintered product of a target substance molded into plate form. Metals or metal oxides may be used as the target substance.

As illustrated in FIG. 1B, each of the target material plates 20 of this embodiment is shaped into a disk form. The “disk form” herein not only encompasses circular forms that looks circular, oval or elliptic when viewed in the thickness direction, but also widely encompasses forms such as near-circular or quasi-circular form, and even notched circular form derived from circular or near-circular form but partially notched. The thickness of the target material plates 20 will be described later.

The radionuclide to be produced is exemplified by molybdenum 99 (⁹⁹Mo) as a parent nuclide of technetium 99m, and also by phosphorus 32 (³²p), titanium 44 (⁴⁴Ti), scandium 47 (⁴⁷Sc), copper 64 (⁶⁴Cu), copper 67 (⁶⁷Cu), germanium 68 (⁶⁸Ge), yttrium 90 (⁹⁰Y), and lutetium 177 (¹⁷⁷Lu).

Nomenclature of the nuclear reaction generally follows the rule where the target substance is given on the left, and the product on the right, while placing in between parentheses that contains an incident particle and outgoing particle(s). If the target substance is molybdenum 100, the product is molybdenum 99, the incident particle is radioactive ray (γ), and the particle emitted from the target substance is a single neutron (n), the nuclear reaction is represented by expression (1) below. Note that, in this specification, radioactive ray, electromagnetic wave and photon are synonymous.

¹⁰⁰Mo(γ,n)⁹⁹Mo (1)

For generation of phosphorus 32, titanium 44, scandium 47, copper 64, copper 67, germanium 68, yttrium 90 and lutetium 177, nuclear reactions below may be used. For example, expression (2) means that sulfur 33 irradiated by radioactive ray (γ) emits a proton (p) to yield phosphorus 32. Expression (3) means that titanium 46 irradiated by radioactive ray (γ) emits two neutrons to yield titanium 44. Expression (5) means that zinc 66 irradiated by radioactive ray (γ) emits a proton (p) and a neutron (n) to yield copper 64.

³³S(γ,p)³²P (2)

⁴⁶Ti(γ,2n)⁴⁴Ti (3)

⁴⁸Ti(γ,p)⁴⁷Sc (4)

⁶⁶Zn(γ,pn)⁶⁴Cu (5)

⁶⁸Zn(γ,p)⁶⁷Cu (6)

⁷⁰Ge(γ,2n)⁶⁸Ge (7)

⁹¹Zr(γ,p)⁹⁰Y (8)

¹⁷⁸Hf(γ,p)¹⁷⁷Lu (9)

As described above, the particle emitted from the target substance is not only neutron(s) but also may be a proton, and even also both of neutron and proton. When a target substance (target nucleus) is irradiated by photon (γ) and emits one, or two or more arbitrary particles (x) (two or more particles may be of a single species, or may be of two or more species mixed with each other) to yield a radionuclide, this event is denoted by (γ,x) nuclear reaction.

Now in this embodiment, the description below will deal with the case where the radionuclide to be produced is molybdenum 99, and the target substance is molybdenum 100.

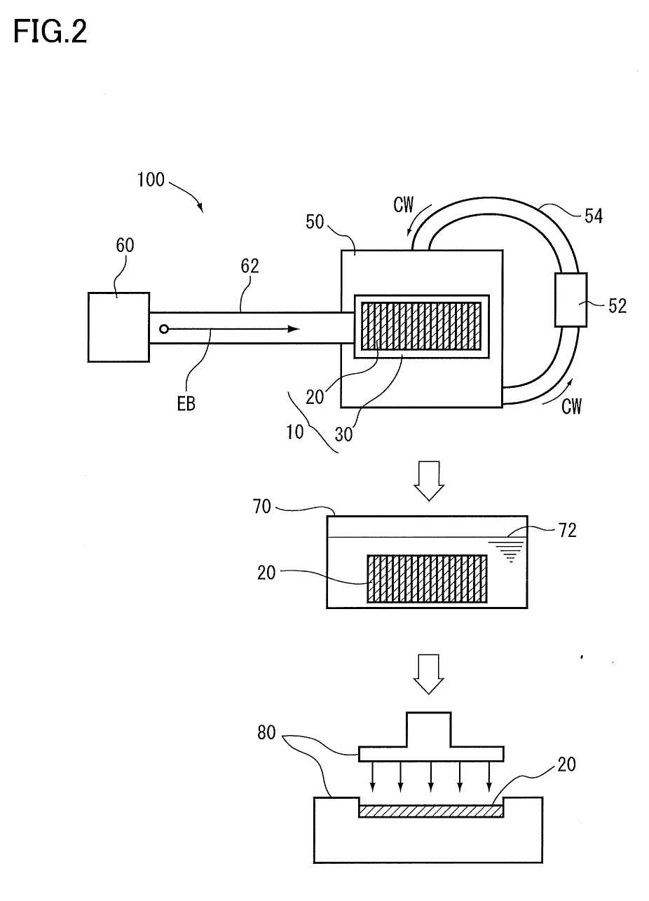

Since molybdenum 99 has a half-life of approximately 3 days, which is longer than the half-life of the its daughter nuclide technetium 99m, so that technetium 99m may be extracted from molybdenum 99 by dissolving technetium 99m into saline or the like, by an extraction procedure called milking, based on the principle of radiation equilibrium. That is, it is possible to produce molybdenum 99 by using a radionuclide producing apparatus 100, and then by extracting technetium 99m at a medical institution or the like, to thereby manufacture a labeling compound; or technetium 99m may be separated and extracted from molybdenum 99 in the radionuclide producing apparatus 100 and then subjected to manufacture of a labeling compound. In this embodiment, a procedure for separating technetium 99m from molybdenum 99, in the radionuclide producing apparatus 100, is illustrated in FIG. 2.

FIG. 2 is a configuration chart illustrating the radionuclide producing apparatus 100 equipped with the target device 10 of this embodiment. The radionuclide producing apparatus 100 has the target device 10, a particle accelerator 60 that produces a particle beam, and an extraction unit 70 that extracts, from the target device 10, a radionuclide produced by irradiating the target material plates 20 with a particle beam.

The particle accelerator 60 is a means for producing a particle beam by accelerating an incident particle. As the incident particle that forms a particle beam capable of inducing a nuclear reaction in a target substance, usable are a variety of particles including proton, deuteron, alpha particle, ion, electron and photon. As the particle accelerator 60, usable are electrostatic accelerator; circular accelerators such as cyclotron and synchrotron; linear accelerator; or microtron based on combination of a circular accelerator and a linear accelerator, which are selectable depending on species of the incident particle and energy level.

This embodiment will exemplify the case where electron is employed as the incident particle, and a linear accelerator (linac) capable of accelerating electron along a straight line is employed as the particle accelerator 60. The particle accelerator 60 is connected with a straight, cylindrical acceleration cavity 62. In the acceleration cavity 62, electrons are accelerated using an electric field, to produce a particle beam (electron beam EB) with a desired level of energy.

The beam output of the radionuclide producing apparatus 100 may be, but not specifically limited to, 10 kW or higher and 100 kW or lower, and preferably 20 kW or higher and 50 kW or lower.

In the radionuclide producing apparatus 100, the particle accelerator 60 and the target material plates 20 are opposed to each other, so that the particle beam (electron beam EB) produced by the particle accelerator 60 is irradiated directly on the target material plates 20. Upon collision of the electron beam EB onto the target material plates 20, bremsstrahlung occurs and bremsstrahlung photons are produced.

In order to induce a nuclear reaction in the target substance, it is desired to make the bremsstrahlung photons with a high fluence collide on the target substance. For this purpose, it has been a conventional practice to make electron beam EB collide on a so-called converter, which is a plate-like component made of a metal element with a large atomic number and a large density, to thereby produce the bremsstrahlung photons, and then to make the bremsstrahlung photons collide on the target substance that is placed on the downstream side of the converter. In contrast in this embodiment that makes use of molybdenum 100, having a large atomic number and a high density, as the target substance, it now becomes possible to produce the bremsstrahlung photons also by collision of electron beam EB on the target substance. Accordingly, in the radionuclide producing apparatus 100 of this embodiment, the electron beam EB is allowed to collide on the target substance (target material plates 20) without using the converter. Since the converter is no more necessary, so that the apparatus may be simplified, and may be freed from tasks of cooling and maintenance of the converter.

However in place of making the electron beam EB incident on the target material plates 20 as in this embodiment, it is alternatively possible to make bremsstrahlung photons BS, having been produced by allowing the particle beam to collide against the converter (not illustrated), incident on the target material plates 20 (see FIG. 1A).

Both of electron beam EB and bremsstrahlung beam (bremsstrahlung photons BS) belong to particle beam composed of particles. In this specification, the phrase stating that “a particle beam is incident on the target material plates 20” covers at least the case where the electron beam EB is directly incident on the target material plates 20, and the case where the bremsstrahlung photons BS, produced as a result of irradiation with the electron beam EB, are incident on the target material plates 20.

The target device 10 is disposed in a cooling unit 50. The cooling unit 50 is fed with cooling water CW. This embodiment illustrates an exemplary case where a heat exchanger 52 and a water supply channel 54 are connected to the cooling unit 50, so as to circulate the cooling water CW through the target device 10. Both ends of the water supply channel 54 communicate with the cooling unit 50, and the heat exchanger 52 is provided halfway on the water supply channel 54. The heat exchanger 52 cools the cooling water CW after being subjected to cooling of the target device 10. Aqueous medium such as pure water is preferably used as the cooling water CW.

The holding frame 30 is a means for holding a plurality of target material plates 20, and for disposing them so that the particle beam (electron beam EB) can collide on the center or around of the target material plates 20 positioned on the front side, which corresponds to the incident side of the electron beam EB (left side in FIG. 2). In this embodiment, the side the particle beam comes into the target material plate 20 is denoted as the front side, meanwhile the side the particle beam or bremsstrahlung photons BS goes out is denoted as the rear side. The description below will be made based on the front-rear direction as denoted above, merely for the convenience of explaining the relative positional relation between the front plate group GRF and the rear plate group GRR in the target device 10, without necessarily limiting the directionality of the target device 10 of this invention during manufacture and distribution thereof.

As illustrated in FIG. 1A, the holding frame 30 in this embodiment holds the target material plates 20 while keeping a space V between a plurality of pairs of adjacent target material plates 20. In this embodiment, the holding frame 30 holds the target material plates 20 while keeping a space V between every adjacent target material plates 20. The cooling water CW flows through the space V to cool the target material plates 20 that are heated by collision with the electron beam EB or bremsstrahlung photons. Although FIG. 1A and FIG. 2 illustrate that the cooling water CW is fed sideways to the direction of arrangement of the target material plates 20 (left-right direction of the individual drawings) and allowed to flow in the in-plane direction of the individual target material plates 20, the directions of supply and flow of the cooling water CW are not limited thereto.

There is a space V between every adjacent target material plates 20. All spaces V may have a same width W or different widths W. The width W of space V means the distance between the adjacent target material plates 20. In this embodiment, the width W of all spaces V is uniform.

The width W of space V is preferably not smaller than a half of the thickness of the thinnest target material plate(s) 20 (minimum thickness), and is preferably not smaller than the minimum thickness. Since too narrow width W of the space V will make the cooling water CW flow less smoothly through the space V due to the viscosity of cooling water CW, so that the width W of the space V is preferably 0.5 mm or larger when an aqueous medium is used as the cooling water CW.

In the extraction unit 70, the radionuclide is extracted from the target material plates 20 by chemical process. Specific procedures of the chemical process are selectable depending on the source material (target substance) of the target material plates 20. When molybdenum 100 is used as the target substance, a typical procedure is such as dissolving the target material plates 20 in an oxidative treatment liquid 72 such as hydrogen peroxide, and then adding a neutralizing agent such as ammonium carbonate. In this way, a molybdate such as ammonium molybdate is produced, together with an acid salt of radionuclide (e.g., technetium 99m) resulted from the (γ,n) reaction. The technetate may be separated from molybdate by a variety of chromatographic methods. The separated technetate (^{99m}technetic acid salt), after neutralized and removed with impurities, may be provided as a labeling compound for radiopharmaceuticals.

Meanwhile, the molybdate removed with the technetate is recovered in a reduced form of molybdenum metal (molybdenum 100), typically by dehydrating the molybdate to expel water admixed therein, and then by heating the molybdate under a reductive atmosphere. The thus recovered molybdenum metal is then fed to a regeneration unit 80 for compression or spark plasma sintering, and regenerated into a disk-like target material plates 20.

Referring now back to FIG. 1A, the target material plates 20 will be detailed. Each of the target material plates 20 is made of a target substance (enriched molybdenum 100 in this embodiment) and made into a disk. Each target material plate 20 has a plate form, and all target material plates 20 have a nearly uniform thickness. In the target device 10, a plurality of target material plates 20 are lined up in an overlapped manner. The phrase stating that “a plurality of target material plates 20 are lined up in an overlapped manner” means that every adjacent target material plates 20 are overlapped at least partially when viewed in the direction of irradiation of particle beam (front-rear direction, or lateral direction in FIG. 1A). More preferably, the centers of the individual target material plates 20 are aligned on a straight line, and the straight line lies in parallel to the direction of irradiation of particle beam. In other words, a set of target material plates 20 held by the holding frame 30 preferably gives a rotation-symmetrical envelope formed around the axis that represents the direction of irradiation of particle beam.

The number of target material plates 20, although given as 20 in FIG. 1A, is not limited thereto, and typically may be 4 to 30. As described previously, the plurality of target material plates 20a positioned on the front side, which corresponds to the incident side of the electron beam EB or bremsstrahlung photons BS, are collectively referred to as the front plate group GRF, and the plurality of target material plates 20b positioned opposite thereto, that is on the rear side, are collectively referred to as the rear plate group GRR. In this embodiment, the average thickness of the target material plates 20a composing the front plate group GRF is smaller than the average thickness of the target material plates 20b composing the rear plate group GRR.

This is because the target material plates 20a in the front plate group GRF are heavily heated under collision with the particle beam, so that the target material plates 20a are thinned to thereby increase the ratio of width W of space V relative to the thickness (occasionally referred to as “vacancy ratio”).

In other words, the ratio of width W of space V between one target material plate 20a composing the front plate group GRF and the neighboring target material plate, relative to the thickness of the one target material plate 20a (vacancy ratio), is larger than the relevant vacancy ratio of the target material plates 20b composing the rear plate group GRR. With such configuration, the target material plates 20a are thermally controlled in an appropriate manner, and are suppressed from melting. The particle beam causes a nuclear reaction and attenuates as it travels through the plurality of target material plates 20a, so that the amount of heat generation from the target material plates 20b in the rear plate group GRR will decrease. It is therefore no longer necessary to increase the vacancy ratio in the rear plate group GRR, and instead, by increasing the abundance ratio of the target material plates 20b and thereby increasing the probability of collision with the particle beam, the radionuclide may be produced effectively.

Simulation results demonstrating such event will be detailed later in Examples 1 to 3.

By using the target device 10 of this embodiment, the radionuclide producing apparatus 100 can now provide a method of producing radionuclide described below (which may occasionally be referred to as “this method”).

This method is intended for producing radionuclide by irradiating the target material plates 20 with the particle beam. According to this method, the plurality of target material plates 20 are lined up in an overlapped manner, while keeping the space V between every adjacent target material plates 20. While feeding a cooling medium (cooling water CW) to the space V, the particle beam is made incident on the target material plates 20. Assuming now that the plurality of target material plates 20a positioned on the front side belong to the front plate group GRF, and that the plurality of target material plates 20b positioned on the rear side belong to the rear plate group GRR, the ratio of the width W of space V adjoining to one target material plate 20a in the front plate group GRF, relative to the average thickness of the target material plates 20a that belong to the front plate group GRF (vacancy ratio), is larger than the relevant vacancy ratio of the target material plates 20b that belong to the rear plate group GRR.

Thus, alternatively to this embodiment, it is also possible to widen the width W of space V before and behind the target material plates 20a in the front plate group GRF, as compared to the width W of space V before and behind the target material plates 20b in the rear plate group GRR. In this way, the vacancy ratio in the front plate group GRF can be made larger than the vacancy ratio in the rear plate group GRR.

It is a matter of choice that how many target material plates 20 counted from the front side should be included into the front plate group GRF, and the subsequent residual plates should be included into the rear plate group GRR. Referring to FIG. 1A, all target material plates 20a composing the front plate group GRF have an uniform thickness, and all target material plates 20b composing the rear plate group GRR again have an uniform thickness, but are thicker than the target material plates 20a. In other words, the plurality of target material plates 20 in this embodiment have two levels of thickness for the target material plates 20a and the target material plates 20b, and they are arranged so that the thickness monotonously increases in the direction from the front plate group GRF towards the rear plate group GRR.

This invention is however not limited to this example, instead allowing that the plurality of target material plates 20a composing the front plate group GRF may contain a plate with a different thickness, and similarly, the plurality of target material plates 20b composing the rear plate group GRR may contain a plate with a different thickness. So long as that the average thickness of the target material plates 20a is smaller than the average thickness of the target material plates 20b, a part of the plurality of target material plates 20a may have a thickness larger than that of a part of the target material plates 20b.

For example, the forefront target material plate 20a may be made thicker than a part of the target material plates 20b. This idea is based on the finding that the particle beam that is incident on the target material plates 20 first travels through the forefront target material plate 20a, and causes maximum heat generation at the target material plate(s) 20a recessed from the front by several number of plates. The details will be explained later in Examples 2 and 3.

In the target material plates 20 of this embodiment, all of the target material plates 20a composing the front plate group GRF have a thickness smaller than the average thickness of all target material plates 20, and all of the target material plates 20b composing the rear plate group GRR have a thickness not smaller than the average thickness of all target material plates 20. With such configuration, the target material plate 20 as a whole may thermally be controlled in an appropriate manner using the cooling water CW and the cooling unit 50 (see FIG. 2), even if a large thermal load were applied entirely to the front plate group GRF by the particle beam with an elevated output. In the embodiment illustrated in FIG. 1A, the number (7 in the drawing) of target material plates 20a composing the front plate group GRF is smaller than the number (11 in the drawing) of target material plates 20b composing the rear plate group GRR.

Note that, as in Second Embodiment described later, the number of target material plates 20a composing the front plate group GRF may be larger than the number of target material plates 20b composing the rear plate group GRR. Specific thickness and number of the target material plate 20a and the target material plate 20b may appropriately be determined depending on the output of particle beam.

The target material plates 20a composing the front plate group GRF preferably have a thickness of 0.2 mm or larger and 10 mm or smaller. As described previously, the space V through which the cooling water CW flows preferably has a width W of not smaller than a half of the thickness of the thinnest target material plate(s) 20. In other words, the target material plates 20a composing the front plate group GRF preferably has a minimum thickness of twice the width of space V or smaller.

The thickness of the target material plates 20b composing the rear plate group GRR is not specifically limited. Although the thickness in this embodiment increases discontinuously at the boundary between the target material plate 20a and the target material plate 20b, this invention is not limited thereto. More specifically, the target material plates 20 may alternatively be arranged so that the thickness of the target material plates 20a increases gradually towards the rear side in the front plate group GRF, and also increases in a finely graduated manner (or, in a multi-stepwise manner) across the boundary between the front plate group GRF and the rear plate group GRR.

The diameter of the target material plates 20 composing both of the front plate group GRF and the rear plate group GRR is preferably, but not specifically limited to, 10 mm or larger and 50 mm or smaller. A possible maximum diameter of the target material plates 20 may be determined depending on the amount of heat generation caused by the particle beam and the cooling efficiency of the cooling water CW. While all target material plates 20 in this embodiment have a same diameter and arranged concentrically as illustrated in FIG. 1B, such plurality of target material plates 20 may have different diameters as described later in Third Embodiment.

The plurality of target material plates 20 of this embodiment are loaded on the holding frame 30, and when put into production of radionuclide, they are lined up while keeping the space V in between. During distribution before being loaded on the holding frame 30, the plurality of target material plates 20 are not necessarily spaced from each other, and instead may be stacked in direct contact with one another and enclosed and sealed in a shipping container (not illustrated). In this case, it is recommendable to dispose the target material plates 20a on one side in a set of the target material plates 20, and to dispose the target material plates 20b on the other side, so that the target material plates 20 can be loaded on the holding frame 30 while keeping the order of arrangement during distribution unchanged.

### Second Embodiment

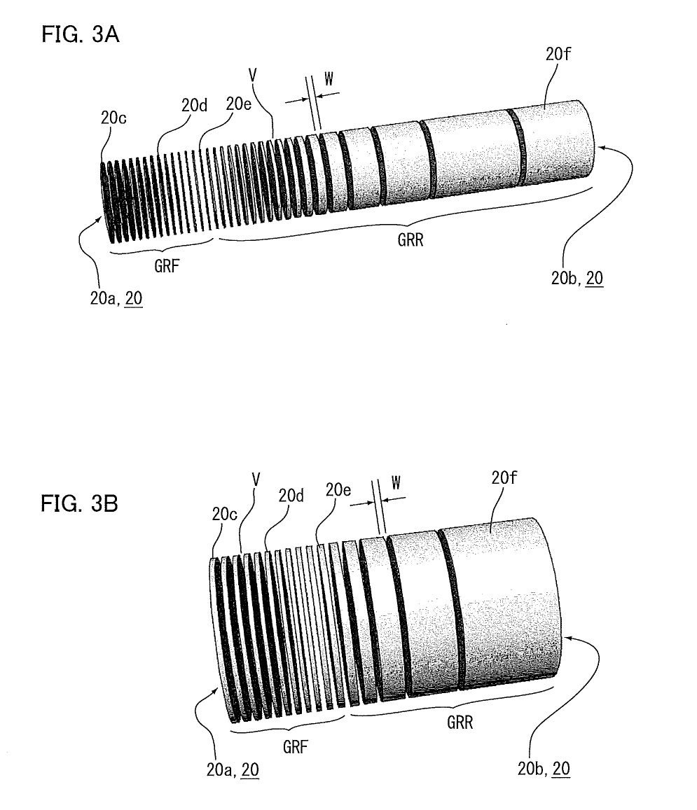

FIG. 3A is a schematic side elevation illustrating an arrangement of the target material plates of a second embodiment, and FIG. 3B is a schematic side elevation illustrating an arrangement of the target material plates 20 according to a modified example of the second embodiment. The left side of each drawing corresponds to the front side the particle beam comes in.

The plurality of target material plates 20a contained in the front plate group GRF are arranged so that the thickness thereof once decreases and then increases in the direction from the front side towards the rear side.

In this embodiment, the target material plates 20a composing the front plate group GRF are arranged so that the thickness gradually reduces in the direction from a forefront target 20c to a thinnest target 20d having a smallest thickness. The target material plates 20a are arranged so that the thickness gradually increases in the direction from the thinnest target 20d towards a boundary target 20e positioned at the boundary between the front plate group GRF and the rear plate group GRR. The target material plates 20b composing the rear plate group GRR are positioned behind the boundary target 20e, and all of them have the thickness larger than that of the boundary target 20e. The target material plates 20b, excluding a hindmost target 20f positioned at the rear end, have the thickness that gradually increases in the direction from the front to the rear. The thickness of the hindmost target 20f may arbitrarily be determined so as to control the total mass of the target material plates 20.

The boundary target 20e may arbitrarily be specified by any target, so long as it is positioned behind the thinnest target 20d, and followed by the plurality of target material plates 20b. In this embodiment, the boundary target 20e is specified by one target, among the target material plates positioned behind the thinnest target 20d, that appears first to have the thickness larger than that of the forefront target 20c.

In the target material plates 20 of this embodiment, the number (15 in the drawing) of the target material plates 20a composing the front plate group GRF is smaller than the number (18 in the drawing) of the target material plates 20b composing the rear plate group GRR.

Among the target material plates 20 of the second embodiment illustrated in FIG. 3A, all of the target material plates 20a composing the front plate group GRF have the thickness values smaller than the average thickness of the entire target material plates 20. Also all of the target material plates 20b composing the rear plate group GRR have the thickness values not smaller than the average thickness of the entire target material plates 20.

At the boundary between the front plate group GRF and the rear plate group GRR, that is, before and behind the boundary target 20e, the thickness of the target material plates 20 gradually increases in a multi-stepwise manner. The width W of space V between every adjacent target material plates 20 is set uniform. The vacancy ratio of the target material plates 20 therefore gradually decreases in the direction from the front plate group GRF towards the rear plate group GRR. In this way, heating caused by the particle beam is prevented from being maximized distinctively at a certain target material plate 20.

The target material plates 20 of a modified example illustrated in FIG. 3B are different from those in second embodiment previously illustrated in FIG. 3A, in the total number thereof, and in that the hindmost target 20f is thickest. Also the target material plates 20 in this modified example are arranged so that the thickness thereof once decreases in the direction from the front side towards the rear side, that is, from the forefront target 20c towards the thinnest target 20d, and then increases in the direction towards the boundary target 20e. The boundary target 20e is a target plate that is positioned behind the thinnest target 20d, and appears first to have the thickness larger than that of the forefront target 20c. In the target material plates 20 of this modified example, the number (11 in the drawing) of the target material plates 20a composing the front plate group GRF is larger than the number (5 in the drawing) of the target material plates 20b composing the rear plate group GRR.

Among the target material plates 20 of this modified example, the hindmost target 20f that is most moderately heated by the particle beam is made thickest. In other words, the vacancy ratio is minimized at the hindmost target 20f. In this way, the heat may be controlled in a relatively uniform manner over the entire target material plates 20.

### Third Embodiment

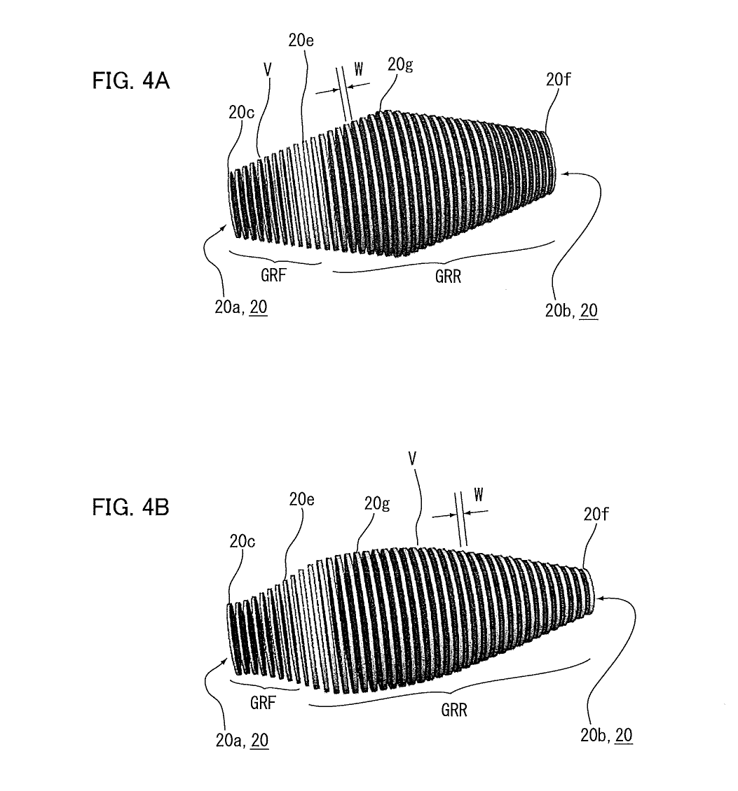

FIG. 4A is a schematic side elevation illustrating an arrangement of the target material plates 20 of a third embodiment, and FIG. 4B is a schematic side elevation illustrating an arrangement of the target material plates 20 according to a modified example of the third embodiment. The left side of each drawing corresponds to the front side the particle beam comes in.

The target material plates 20 of the third embodiment are characterized in that the target material plates 20a composing the front plate group GRF have the diameters smaller than the diameters of the target material plates 20b composing the rear plate group GRR. The phrase stating that “the target material plates 20a have the diameters smaller than the diameters of the target material plates 20b” is not based on comparison between the average diameter of the target material plates 20a and the average diameter of the target material plates 20b, but means that the diameter of at least one plate contained in the target material plate 20a is smaller than the diameters of at least a part of the target material plates 20b.

As illustrated in FIG. 4A and FIG. 4B, the diameters of a part of the target material plates 20b positioned in the rear side in the rear plate group GRR (right side in the drawings) may be same or smaller than the diameters of the target material plates 20a composing the front plate group GRF. In this context, the average diameter of the target material plates 20b composing the rear plate group GRR may be smaller than the average diameter of the target material plates 20a composing the front plate group GRF.

The target material plate positioned in the forefront in the front plate group GRF (forefront target 20c) has the diameter smaller than the maximum diameter of the entire target material plates 20. In other words, a target different from the forefront target 20c, among the target material plates 20, has the maximum diameter. In this embodiment, one target positioned between the forefront target 20c and the hindmost target 20f, among the target material plates 20, is given as a largest target 20g with a maximum diameter. One target positioned right in the middle between the forefront target 20c and the largest target 20g is set as the boundary target 20e, so that the targets within the range from the forefront target 20c to the boundary target 20e are grouped into the front plate group GRF, and the targets following behind the boundary target 20e are grouped into the rear plate group GRR.

In the target material plates 20 of this embodiment, as illustrated in FIG. 4A, at least a part of the plurality of target material plates 20a (all of the target material plates 20a in this embodiment) composing the front plate group GRF are arranged so that the diameter thereof increases in the direction from the front side towards the rear side. Meanwhile at least a part of the plurality of target material plates 20b composing the rear plate group GRR, more specifically the target material plates 20b following behind the largest target 20g, are arranged so that the diameter thereof decreases in the direction from the front side towards the rear side. In other words, within the range from the forefront target 20c to the largest target 20g, there are lined up the target material plates 20 in an increasing order of their diameter, in the direction from the front side towards the rear side, meanwhile within the range from the largest target 20g to the hindmost target 20f, there are lined up the target material plates 20 in a decreasing order of their diameter, in the direction from the front side towards the rear side. The number of the target material plates 20a composing the front plate group GRF is smaller than the number of target material plates 20b composing the rear plate group GRR.

A set of the target material plates 20 of this embodiment gives an overall profile such that two truncated cones are joined. In more detail, two truncated cones are joined at the bottom faces with their top faces directed to opposite directions, that is, front and rear. The diameter of the target material plates 20 monotonously increases within the range from the forefront target 20c to the boundary target 20e, and then monotonously decreases within the range from the largest target 20g to the hindmost target 20f. All target material plates 20 are shaped into a disk, with the centers thereof aligned on a straight line.

The width W of space V between every adjacent target material plates 20 is uniform, and all target material plates 20 have the same thickness. In this embodiment, the target material plates 20 are arranged in mirror symmetry on both sides of the largest target 20g.

In this embodiment illustrated in FIG. 4A, the target material plates 20a composing the front plate group GRF (that is, at least a part of the target material plates 20) are arranged so that the diameter thereof increases in the direction from the front side towards the rear side. Such profile of an envelope of the target material plates 20 that is widened towards the rear side conforms to the a distribution profile of the bremsstrahlung photons produced under irradiation of the particle beam onto the target material plates 20, as will be explained later in Examples 4 and 5. More specifically, the distribution profile of the bremsstrahlung photons is represented by a shape widened, in the front side the particle beam comes in, in the direction from the front side towards the rear side. Hence the plurality of target material plates 20a, positioned to the front side the particle beam comes in, are arranged so that the diameter thereof increases in the direction from the front side towards the rear side.

By tuning the diameter of the target material plates 20 position by position in the front-rear direction, it is now possible to make effective use of bremsstrahlung photons that softly spreads radially from the center axis of the target material plates 20 along which the particle beam comes in, up to beyond the outer edges thereof, and thereby to trigger the nuclear reaction.

In more details, the distribution profile of the bremsstrahlung photons has a spindle shape that is mostly widened at a position closer to the front side, or, a shape of candle flame that is fallen sideways and pointed to the rear side. The distribution profile of the bremsstrahlung photons may also be resembled to an arrowhead pointed to the rear side. The distribution profile of the bremsstrahlung photons is therefore narrowed in the range behind the widest portion. Meanwhile in a modified example of this embodiment illustrated in FIG. 4B, at least a part of the target material plates 20 (target material plates 20a) are arranged so that the diameter thereof once increases in the direction from the front side towards the rear side, and then decreases. The target material plates 20b are arranged behind the largest target 20g, so that the diameter thereof gradually decreases.

A set of target material plates 20 of this modified example is different from the third embodiment (see FIG. 4A) in that the largest target 20g is positioned more close to the front side (left side in FIG. 4B) rather than at right in the middle in the front-rear direction. By arranging the target material plates 20 having different diameters in this way, the profile of an envelope of a set of target material plates 20 may more precisely be fitted to the fluence distribution profile of the bremsstrahlung photons inside the set of target material plates 20.

### EXAMPLES

This invention will further be detailed below, referring to Examples and Comparative Examples.

### Example 1

Paragraphs below will exemplify a method of determining the size of target material plates used for producing molybdenum 99 based on the ¹⁰⁰Mo (γ,n)⁹⁹Mo reaction.

Electron beam was used as the particle beam, at an electron energy of 40 MeV, a beam output of 100 kW (at an average beam current of 2.5 mA), and a beam diameter of 15 mm.

Target material plates are made of ¹⁰⁰Mo as a target substance, and are shaped into a disk form with a diameter Φ of 15 mm. The total mass of the target substance (metal ¹⁰⁰Mo) was 100 g.

Under such conditions, an optimum thickness of the ¹⁰⁰Mo disks, used as the target material plates, was calculated. More specifically, using the Monte-Carlo simulation, the amount of heat generation of each target material plate and the fluence distribution of the bremsstrahlung photons were analyzed while varying the thickness of the target material plates, and a combination of the thickness of the target material plates was calculated, so that the amount of heat generation would not exceed the upper limit of the water-cooling capacity. Assuming that 15-mm-diameter, disk-formed target material plates are cooled on both surfaces thereof, with a cooling water fed through a passage of 1 mm wide, then the upper limit of the water cooling capacity per each target material plate was calculated to be approximately 1 kW.

The thicker as possible the target material plate on the upstream side (front side) the electron beam EB comes in, the higher the yield will be, since the target material plate can be collided with the electron beam and bremsstrahlung photons having higher energies. An excessive thickness of the target material plates, however, makes them thermally uncontrollable since the heat overwhelms the water-cooling capacity.

The calculation revealed that molybdenum 99 was produced most effectively under the conditions described above, by configuring the target device with 33 target material plates each having the thickness listed in Table 1 below. In Table 1, the upper rows contain the position numbers of the target material plates lined up in the direction from the front side towards the rear side and the thickness of the individual plates. The bottom row contains numerals that represent the yield of ⁹⁹Mo from the individual target material plates per one gram of target substance and per one electron in the beam, given in [N/source/g], where “N” represents the number of produced ⁹⁹Mo atoms, “source” represents the number of incident electrons in the electron beam, and “g” represents the mass of target substance (¹⁰⁰Mo).

The order of the target material plates shown in Table 1 corresponds to that of the target material plates 20 of the second embodiment, illustrated in FIG. 3A.

TABLE 1

| | No. | | | | | | | | |
|---|---|---|---|---|---|---|---|---|---|
| | 1 | 2 | 3 | 4 | 5 | 6 | 7 | 8 | 9 |
| Thickness | 0.3 | 0.29 | 0.28 | 0.28 | 0.28 | 0.27 | 0.27 | 0.27 | 0.27 |
| mm | | | | | | | | | |
| ⁹⁹Mo | 3.00E−06 | 6.20E−06 | 1.10E−05 | 1.40E−05 | 1.90E−05 | 2.20E−05 | 2.40E−05 | 2.40E−05 | 2.90E−05 |
| Yield | | | | | | | | | |
| | No. | | | | | | | | |
| | 10 | 11 | 12 | 13 | 14 | 15 | 16 | 17 | 18 |
| Thickness | 0.27 | 0.28 | 0.28 | 0.29 | 0.3 | 0.31 | 0.33 | 0.34 | 0.37 |
| mm | | | | | | | | | |
| ⁹⁹Mo | 3.00E−05 | 3.20E−05 | 3.50E−05 | 3.60E−05 | 3.90E−05 | 4.00E−05 | 3.60E−05 | 4.00E−05 | 4.00E−05 |
| Yield | | | | | | | | | |
| | No. | | | | | | | | |
| | 19 | 20 | 21 | 22 | 23 | 24 | 25 | 26 | 27 |
| Thickness | 0.4 | 0.43 | 0.46 | 0.51 | 0.58 | 0.65 | 0.76 | 0.93 | 1.2 |
| mm | | | | | | | | | |
| ⁹⁹Mo | 3.90E−05 | 3.60E−05 | 3.70E−05 | 3.80E−05 | 3.30E−05 | 3.20E−05 | 2.90E−05 | 2.70E−05 | 2.50E−05 |
| Yield | | | | | | | | | |

No.

| | 28 | 29 | 30 | 31 | 32 | 33 |
|---|---|---|---|---|---|---|
| Thickness | 1.7 | 2.8 | 5.1 | 8.4 | 16.1 | 13.2 |
| mm | | | | | | |
| ⁹⁹Mo | 2.10E−05 | 1.70E−05 | 1.30E−05 | 8.10E−06 | 3.80E−06 | 1.70E−06 |
| Yield | | | | | | |

The analysis revealed that, in Example 1, the yield of ⁹⁹Mo atoms collectively from 33 target material plates determined by summation was found to be 1.1×10⁻⁵ [N/source/g].

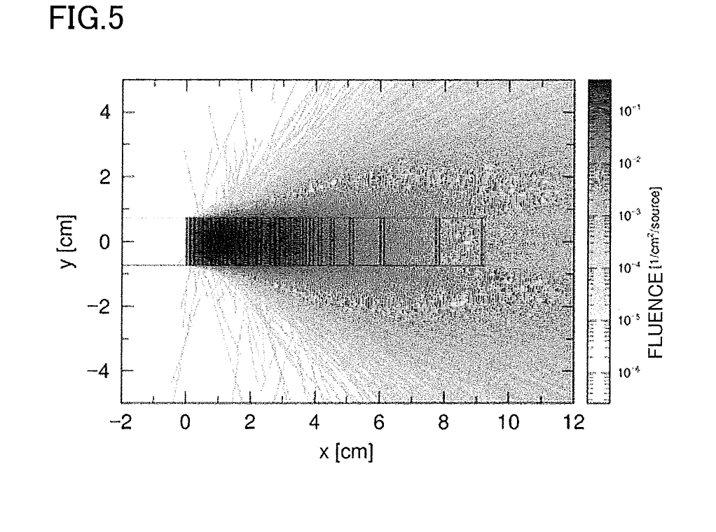

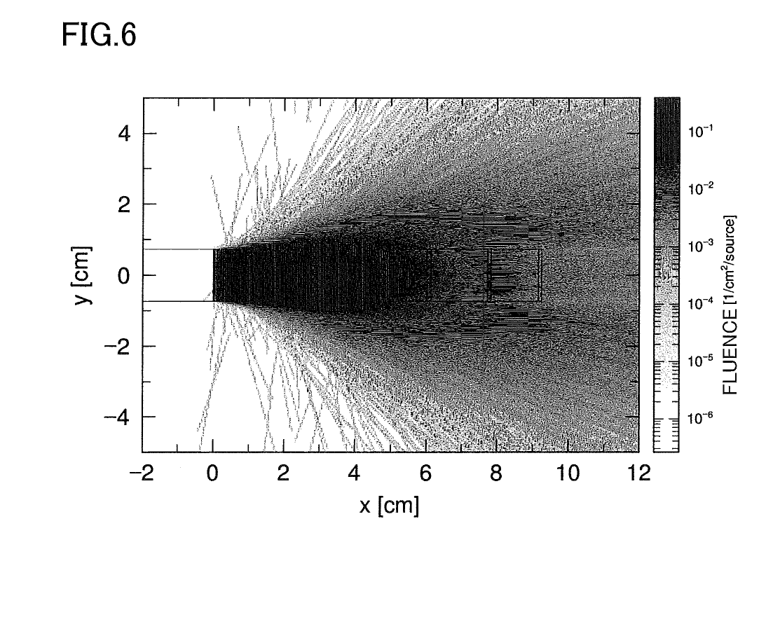

FIG. 5 and FIG. 6 show plots of a fluence distribution of the bremsstrahlung photons with an energy in the range from 10 MeV to 20 MeV, over the target material plates of Example 1, taken at the center sectional plane of the target material plates. Photon with an energy in the range from 10 MeV to 20 MeV is suitable for inducing ¹⁰⁰Mo (γ,n) ⁹⁹Mo reaction. The fluence of bremsstrahlung photons is proportional to the number of occurrence of nuclear reaction, that is, the yield of a desired radionuclide. FIG. 6 is merely a contrast-changed version of FIG. 5, based on an altered gradation representing the fluence of bremsstrahlung photons, showing the same distribution profile of bremsstrahlung photons as in FIG. 5. In both of FIG. 5 and FIG. 6, dark portions correspond to high fluence of bremsstrahlung photons, indicating the region where the desired radionuclide may be produced efficiently.

### Example 2

The analysis was conducted in the same way as in Example 1, with some parameters altered.

The conditions were same as those in Example 1, except that the beam diameter of electron beam was set to 30 mm, the diameter of target material plate was set to 30 mm, and the total mass of the target substance (metal ¹⁰⁰Mo) was set to 300 g. Assuming that 30-mm-diameter, disk-formed target material plates are cooled on both surfaces thereof, with a cooling water fed through a passage of 1 mm wide, then the upper limit of the water cooling capacity per each target material plate was calculated to be approximately 3.7 kW. A combination of thickness of the target material plates was calculated so that the amount of heat generation would not exceed the upper limit of the water-cooling capacity.

The calculation revealed that molybdenum 99 was produced most effectively under the conditions described above, by configuring the target device with 16 target material plates each having the thickness listed in Table 2 below. In Table 2, the upper rows contain the position numbers of the target material plates lined up in the direction from the front side towards the rear side and the thickness of the individual plates. The bottom row contains numerals that represent the yield [N/source/g] of ⁹⁹Mo from the individual target material plates.

TABLE 2

| | No. | | | | | | | |
|---|---|---|---|---|---|---|---|---|
| | 1 | 2 | 3 | 4 | 5 | 6 | 7 | 8 |
| Thickness | 1.07 | 0.98 | 0.92 | 0.87 | 0.84 | 0.83 | 0.84 | 0.87 |
| mm | | | | | | | | |
| ⁹⁹Mo | 1.80E−06 | 5.20E−06 | 7.60E−06 | 9.80E−06 | 1.20E−05 | 1.30E−05 | 1.40E−05 | 1.50E−05 |
| Yield | | | | | | | | |
| | No. | | | | | | | |
| | 9 | 10 | 11 | 12 | 13 | 14 | 15 | 16 |
| Thickness | 0.92 | 1.02 | 1.19 | 1.5 | 2.18 | 4.15 | 8.5 | 17.2 |
| mm | | | | | | | | |
| ⁹⁹Mo | 1.50E−05 | 1.50E−05 | 1.40E−05 | 1.30E−05 | 1.20E−05 | 9.40E−06 | 6.50E−06 | 3.20E−06 |
| Yield | | | | | | | | |

Note that the order of the target material plates shown in Table 2 corresponds to that of the target material plates 20 according to a modified example of the second embodiment, illustrated in FIG. 3B.

The analysis revealed that, in Example 2, the yield of ⁹⁹Mo atoms collectively from 16 target material plates determined by summation was found to be 7.0×10⁻⁶ [N/source/g].

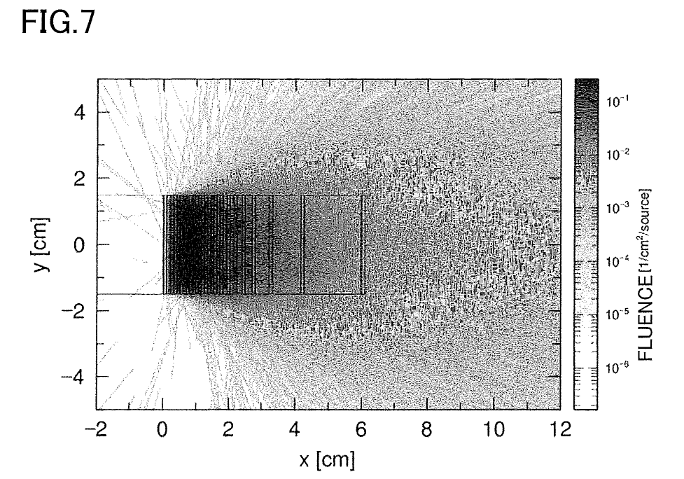

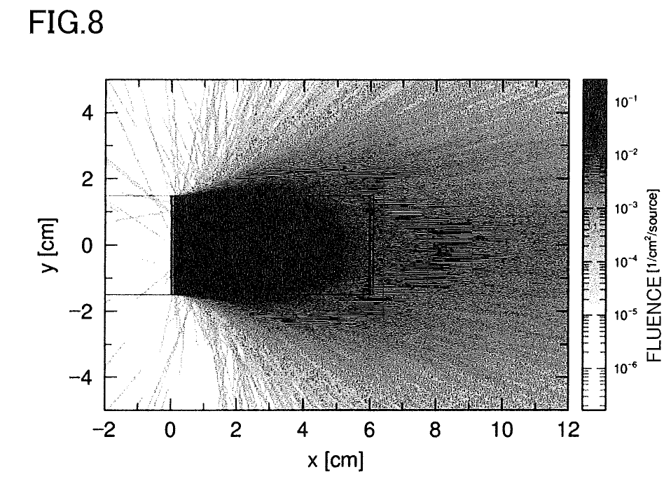

FIG. 7 shows plots of a fluence distribution of the bremsstrahlung photons with an energy in the range from 10 MeV to 20 MeV, over the target material plates of Example 2, taken at the center sectional plane of the target material plates. FIG. 8 is merely a contrast-changed version of FIG. 7, based on an altered gradation representing the fluence of bremsstrahlung photons, showing the same distribution profile of bremsstrahlung photons as in FIG. 7.

### Example 3

The analysis was conducted under the same conditions as in Example 2, except that only two levels of thickness of the target material plates were combined as illustrated in FIG. 1A. The analysis revealed that molybdenum 99 was produced most effectively when 14 target material plates 20a of 0.8 mm thick were placed on the upper stream side (front plate group GRF), and 16 target material plates 20b of 2.0 mm thick were placed on the lower stream (rear plate group GRR).

The calculation revealed that, in Example 3, the yield of ⁹⁹Mo atoms collectively from the entire target material plates was found to be 6.6×10⁻⁶ [N/source/g].

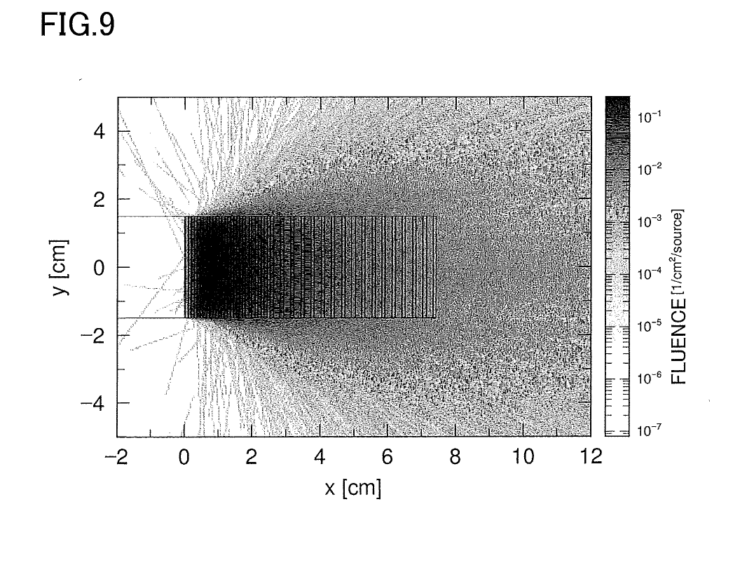

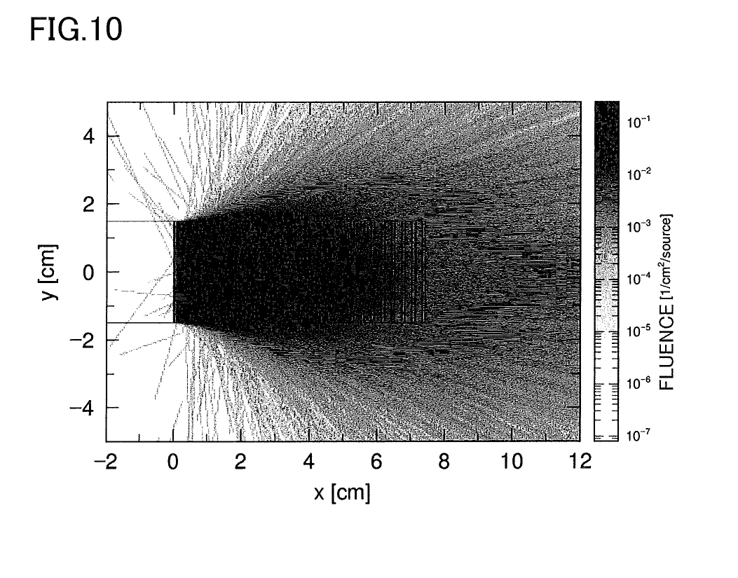

FIG. 9 shows plots of a fluence distribution of the bremsstrahlung photons with an energy in the range from 10 MeV to 20 MeV, over the target material plates of Example 3, taken at the center sectional plane of the target material plates. FIG. 10 is merely a contrast-changed version of FIG. 9, based on an altered gradation representing the fluence of bremsstrahlung photons, showing the same distribution profile of bremsstrahlung photons as in FIG. 10.

As seen in FIG. 7 and FIG. 9, the fluence of bremsstrahlung photons was found to be maximum not at the forefront target material plate, but at around the target material plates recessed from the front by several number of plates. This is supposedly because the particle beam (electron beam EB) is transmissive, and the propagation thereof is sharply bent not only in the forefront target material plate but also over several numbers of plates to emit photons, and thereby the fluence of the bremsstrahlung photons becomes maximum over the target material plates recessed by several number of plates. The amount of heat generation therefore becomes maximum not at the forefront target 20c (see FIG. 3A and FIG. 3B), but at a target material plate 20a recessed from the front by several number of plates. For this reason, as summarized above in Table 1 and Table 2, the target material plates were thinned mostly at the 6th through 10th positions in Example 1, and at the 6th position in Example 2, while keeping in between large ratios of vacancy, with the forefront target material plate given a larger thickness.

### Comparative Example 1

Analysis was conducted under the same conditions as in Example 2, except that the thickness of all target material plates was set uniform. The analysis revealed that molybdenum 99 was produced most effectively by configuring the target device with 53 target material plates of 0.83 mm thick.

The calculation revealed that, in Comparative Example 1, the yield of ⁹⁹Mo atoms from the entire target material plates was found to be 6.1×10⁻⁶ [N/source/g].

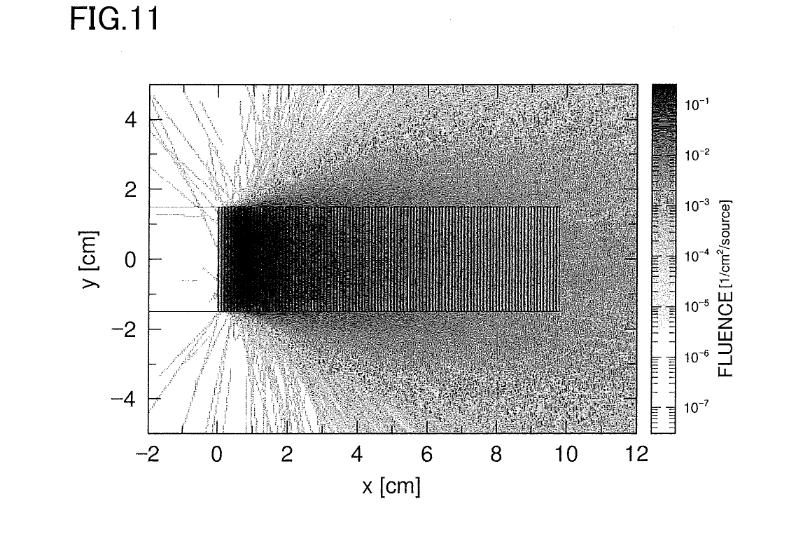

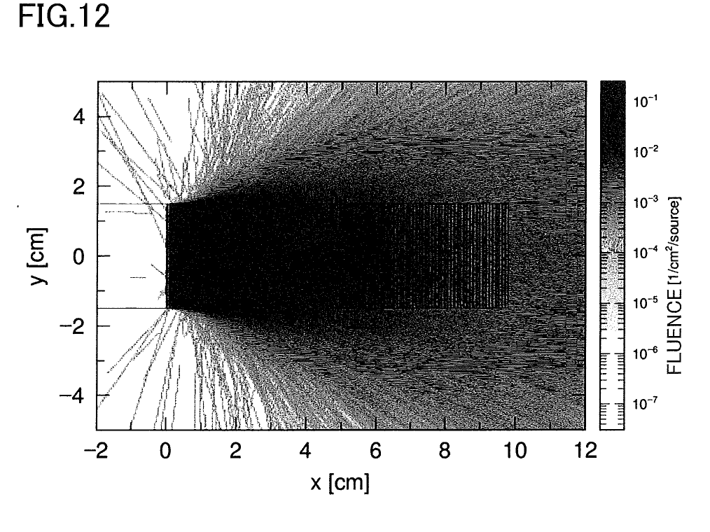

FIG. 11 shows plots of a fluence distribution of the bremsstrahlung photons with an energy in the range from 10 MeV to 20 MeV, over the target material plates of Comparative Example 1, taken at the center sectional plane of the target material plates. FIG. 12 is merely a contrast-changed version of FIG. 11, based on an altered gradation representing the fluence of bremsstrahlung photons, showing the same distribution profile of bremsstrahlung photons as in FIG. 11.

From comparative study on Examples 2 and 3, and Comparative Example 1 made on the basis of the yield of molybdenum 99 in Comparative Example 1, the yield in Example 2 was found to be as high as 114%, and the yield in Example 3 was found to be as high as 108%. It was understood from the results that the radionuclide was manufactured effectively, simply by varying the thickness of the target material plates from position to position, and more specifically by reducing the average thickness for the front plate group GRF smaller than that for the rear plate group GRR, even if the amount of consumption of the target substance remained unchanged (300 g).

### Example 4

As have been illustrated in FIG. 6, FIG. 8, FIG. 10 and FIG. 12, it was found that the fluence distribution of the bremsstrahlung photons tends to diverge towards the downstream side of the particle beam (rightward in the individual drawings). In particular, portions corresponded to high fluence of the bremsstrahlung photons were found to have a spindle shape like a candle flame fallen sideways and pointing the downstream side.

The present inventors thus tried to fit an envelope of a set of target material plates to the distribution profile of the high fluence region of the bremsstrahlung photons.

More specifically, as illustrated in FIG. 4A, 40 target material plates were arranged so that the diameter thereof increases in the direction from the front side towards the rear side and then decreases, so as to give an overall profile such that two truncated cones were joined. Other conditions for analysis were same as those in Example 1.

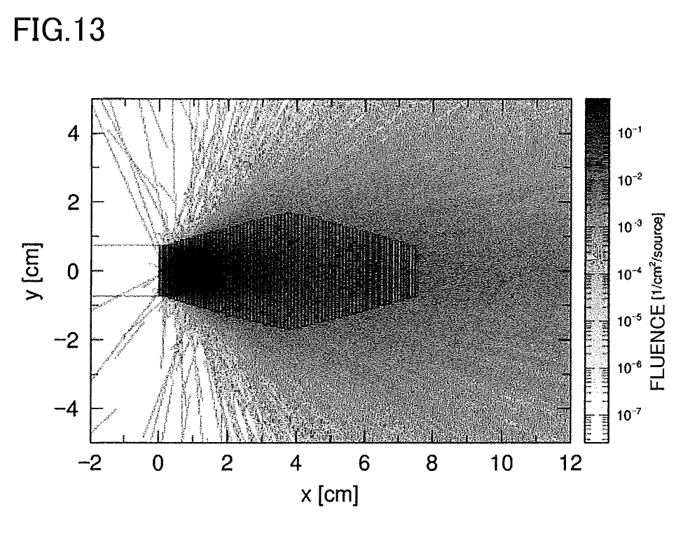

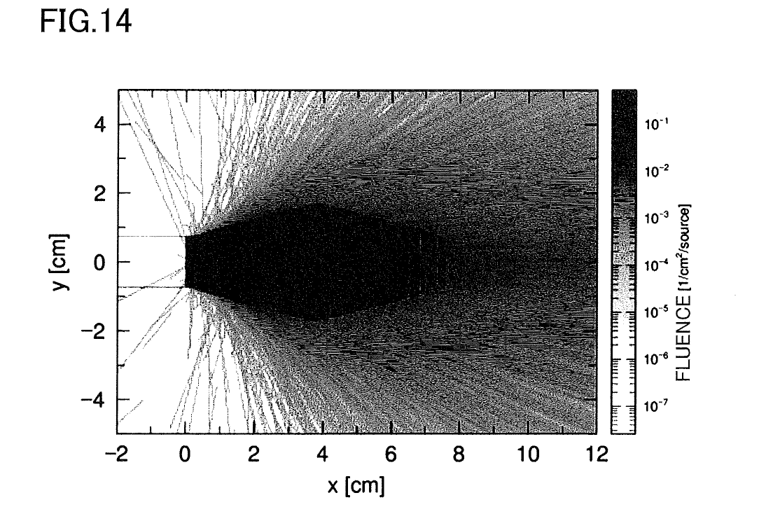

As shown in FIG. 13 and FIG. 14, the analysis was successful enough to fit the dark portions that correspond to abundance of the bremsstrahlung photons, nearly to the envelope of the set of target material plates. FIG. 13 shows plots of a fluence distribution of the bremsstrahlung photons with an energy in the range from 10 MeV to 20 MeV, over the target material plates of Example 4, taken at the center sectional plane of the target material plates. FIG. 14 is merely a contrast-changed version of FIG. 13, based on an altered gradation representing the fluence of bremsstrahlung photons, showing the same distribution profile of bremsstrahlung photons as in FIG. 13. More specifically, the diameter Φ of the forefront target 20c was set to 15 mm, and the diameter Φ of the largest target 20g was set to 34 mm (see FIG. 4A).

The yield of Mo atoms from the entire target material plates in Example 4 was found to be as high as 1.0×10⁻⁵ [N/source/g].

It was understood from the results that the target material plates in Example 4 could produce a large amount of radionuclide with a less amount of consumption of the target substance. This is because the diameter of target material plates is no longer necessary to exceed the diameter of electron beam, so that the target substance will not be consumed excessively, and conversely, the diameter of target material plates is no longer necessarily smaller than the diameter Φ of electron beam, so that the peripheral bremsstrahlung photons will not be wasted.

### Example 5

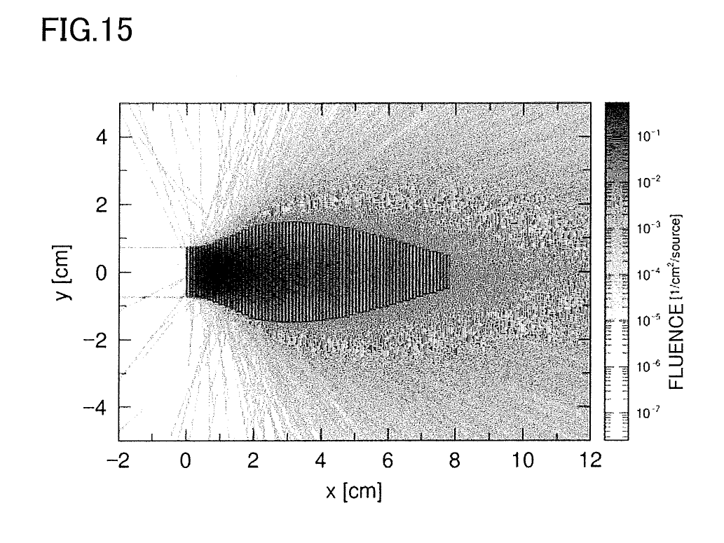

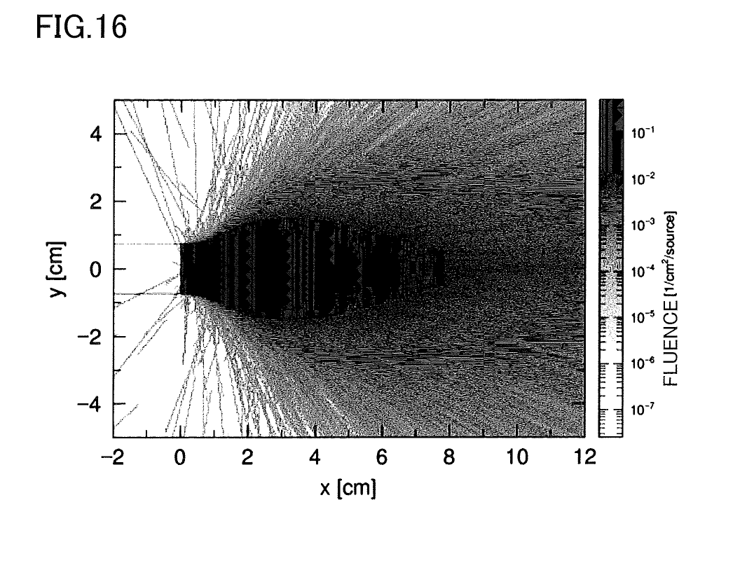

Analysis was conducted under the same conditions as in Example 4, except that, as illustrated in FIG. 4B, an envelope of a set of 40 target material plates was made in to a spindle shape like a candle flame fallen sideways and pointing the rear side. As shown in FIG. 15 and FIG. 16, the analysis was successful enough to fit the dark portions that correspond to abundance of the bremsstrahlung photons, closely to the envelope of the set of target material plates. FIG. 15 shows plots of a fluence distribution of the bremsstrahlung photons with an energy in the range from 10 MeV to 20 MeV, over the target material plates of Example 5, taken at the center sectional plane of the target material plates. FIG. 16 is merely a contrast-changed version of FIG. 15, based on an altered gradation representing the fluence of bremsstrahlung photons. More specifically, the diameter Φ of the forefront target 20c was set smallest to 15 mm, and the diameter Φ of the largest target 20g was set to 30 mm (see FIG. 4B).

The calculation revealed that, in Example 5, the yield of ⁹⁹Mo atoms from the entire target material plates was again found to be as high as 1.2×10⁻⁵ [N/source/g].

### Comparative Example 2

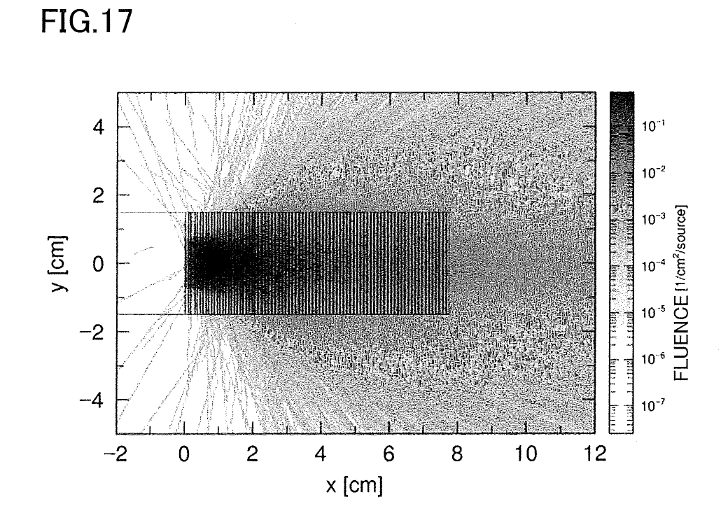

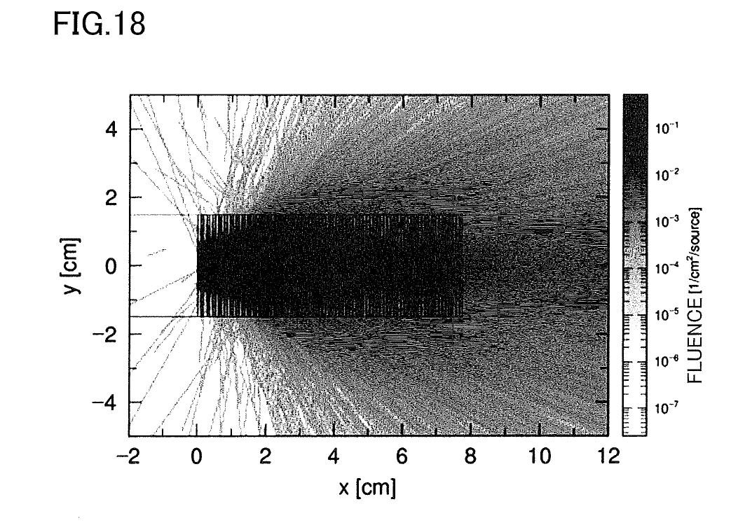

Analysis was conducted under the same conditions as in Examples 4 and 5, except that the target material plates, all being 30 mm in diameter Φ, were arranged to give a cylindrical profile as a whole. The analysis revealed that, as illustrated in FIG. 17 and FIG. 18, there was produced a region where no bremsstrahlung photons travel through the target material plate, on the upstream side (left in the individual images), meaning that the target substance was wasteful. FIG. 17 shows plots of a fluence distribution of the bremsstrahlung photons with an energy in the range from 10 MeV to 20 MeV, over the target material plates of Comparative Example 2, taken at the center sectional plane of the target material plates. FIG. 18 is merely a contrast-changed version of FIG. 17, based on an altered gradation representing the fluence of bremsstrahlung photons. In other words, when compared leaving the amount of consumption of the target substance unchanged, it was predicted that Comparative Example 2 would yield a smaller amount of ⁹⁹Mo atoms, as compared with Example 4 and Example 5.

The yield of ⁹⁹Mo atoms from the entire target material plates in Comparative Example 4 was then actually found to be as low as 7.7×10⁻⁶ [N/source/g].

From comparative study on Examples 4 and 5, and Comparative Example 2 made on the basis of the yield of molybdenum 99 in Comparative Example 2, the yield in Example 4 was found to be as high as 130%, and the yield in Example 5 was found to be surprisingly as high as 156%. It was understood from the results that the radionuclide was manufactured effectively, by varying the thickness of the target material plates from position to position, and by fitting an envelope of the set of target material plates to the distribution profile of the high fluence region of the bremsstrahlung photons, even if the amount of consumption of the target substance remained unchanged (300 g).

### Example 6

As has been described previously, for production of photons based on bremsstrahlung using an electron beam particle accelerator, it has been a general practice to use a converter that is made of a metal element having a larger atomic number and density, and capable of producing bremsstrahlung in a highly efficient manner. The same will also apply to production of radionuclides by any other (γ,x) reactions.

In contrast, for mass production of radionuclides that consumes a large amount of target substance per irradiation, the total thickness of the target material plates loaded in the direction of travel of particle beam will be sufficiently large. It is therefore predicted that the yield of radionuclides in total will not be affected so much, even if the converter were omitted and instead the target material plates were allowed to function also as the converter.

In order to demonstrate the prediction, the ⁹⁹Mo yield was is calculated under the conditions for Example 1, both for the cases with and without the converter. The converter was assumed to be made of tungsten and 2.0 mm thick.

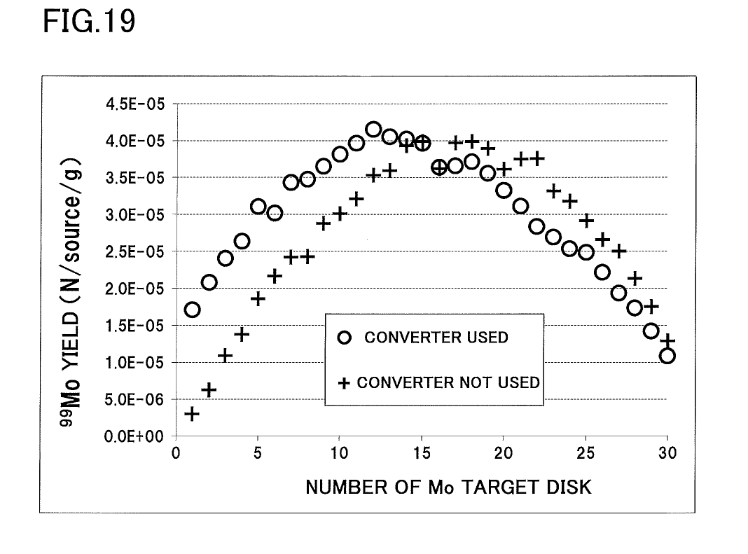

Results of calculation are shown in Table 3 below and FIG. 19. The upper row of Table 3 contains the yield of ⁹⁹Mo atoms [N/source/g] in the individual target material plates when the converter was not used, and the lower row contains the yield of ⁹⁹Mo atoms [N/source/g] in the individual target material plates when the converter was used. The abscissa of FIG. 19 represents the number of the target material plate numbered from the front, and the ordinate represents the yield of ⁹⁹Mo atoms [N/source/g] in the individual target material plate.

When the converter was used, the yield was improved at a position just behind the converter, and became maximum at the 12th target material plate contained in the front group. In contrast, when the converter was not used, a yield exceeding the yield at the first target material plate was first achieved at the fifth target material plate, and the yield reached maximum at the 15th and 17th target material plates.

The total yield achieved with the converter was found to be 1.0×10⁻⁵ [N/source/g], meanwhile the yield achieved without the converter was found to be 1.1×10⁻⁵ [N/source/g], showing not so large difference in the yield from the entire target. In other words, the total yield did not change largely irrespective of presence or absence of the converter, only showing a shift of position of the target material plate(s) where the yield became maximum as illustrated in FIG. 19.

It was therefore confirmed that omission of the converter is beneficial since the relevant cooling and maintenance will no longer be necessary.

TABLE 3

| | No. | | | | | | | | |
|---|---|---|---|---|---|---|---|---|---|
| | 1 | 2 | 3 | 4 | 5 | 6 | 7 | 8 | 9 |
| Converter | 3.00E−06 | 6.20E−06 | 1.10E−05 | 1.40E−05 | 1.90E−05 | 2.20E−05 | 2.40E−05 | 2.40E−05 | 2.90E−05 |
| not used | | | | | | | | | |
| Converter | 1.70E−05 | 2.10E−05 | 2.40E−05 | 2.60E−05 | 3.10E−05 | 3.00E−05 | 3.40E−05 | 3.50E−05 | 3.60E−05 |
| used | | | | | | | | | |
| | No. | | | | | | | | |
| | 10 | 11 | 12 | 13 | 14 | 15 | 16 | 17 | 18 |
| Converter | 3.00E−05 | 3.20E−05 | 3.50E−05 | 3.60E−05 | 3.90E−05 | 4.00E−05 | 3.60E−05 | 4.00E−05 | 4.00E−05 |
| not used | | | | | | | | | |
| Converter | 3.80E−05 | 4.00E−05 | 4.10E−05 | 4.00E−05 | 4.00E−05 | 4.00E−05 | 3.60E−05 | 3.70E−05 | 3.70E−05 |
| used | | | | | | | | | |
| | No. | | | | | | | | |
| | 19 | 20 | 21 | 22 | 23 | 24 | 25 | 26 | 27 |
| Converter | 3.90E−05 | 3.60E−05 | 3.70E−05 | 3.80E−05 | 3.30E−05 | 3.20E−05 | 2.90E−05 | 2.70E−05 | 2.50E−05 |
| not used | | | | | | | | | |
| Converter | 3.60E−05 | 3.30E−05 | 3.10E−05 | 2.80E−05 | 2.70E−05 | 2.50E−05 | 2.50E−05 | 2.20E−05 | 1.90E−05 |
| used | | | | | | | | | |

No.

| | 28 | 29 | 30 | 31 | 32 | 33 |
|---|---|---|---|---|---|---|
| Converter | 2.10E−05 | 1.70E−05 | 1.30E−05 | 8.10E−06 | 3.80E−06 | 1.70E−06 |
| not used | | | | | | |
| Converter | 1.70E−05 | 1.40E−05 | 1.10E−05 | 6.70E−06 | 3.30E−06 | 1.50E−06 |
| used | | | | | | |

Having described this invention referring to the embodiments and Examples, note that this invention is not limited thereto, and encompasses a variety of modified or improved embodiments so long as the purpose of this invention can be achieved.

For example, Example 1 to Example 3 explained the case where the average thickness was varied between the target material plates 20a in the front plate group GRF and the target material plates 20b in the rear plate group GRR; and Example 4 and Example 5 described the case where the diameter was varied between the target material plates 20a in the front plate group GRF and the target material plates 20b in the rear plate group GRR. In this invention, both the average thickness and the diameter may be varied between the target material plates 20a in the front plate group GRF and the target material plates 20b in the rear plate group GRR.

In this invention, the diameter or average thickness of the target material plates positioned to the front side are made smaller than the diameter or average thickness of the target material plates positioned to the rear side. The target material plates, positioned to the front side the particle beam comes in such as electron beam and bremsstrahlung photons, will be given a strong energy from the particle beam and will thus be heated much. Meanwhile, the target material plates positioned to the rear side will be heated moderately as compared with those in the front side. Accordingly, by reducing the average thickness of the target material plates composing the front plate group and thereby to enhance the cooling efficiency, it is now possible to properly control heat over the target device as a whole even if exposed to a high beam output.

The particle beam incident on the target material plate will generate bremsstrahlung photons inside the target material plates as a result of collision. The present inventors have revealed that the fluence distribution of bremsstrahlung photons is given by a distribution profile that is widened in the direction from the front side towards the rear side. Accordingly, by varying the diameter of at least a part of the target material plates from that of the others, and by arranging the target material plates so that the diameter thereof increases in the direction from the front side towards the rear side, the target material plates will have the bremsstrahlung photons collided thereon almost over the entire surfaces, and can therefore improve the efficiency of production of radionuclide.

The aforementioned embodiments and Example encompass the technical spirits below.

(1) A target device that includes a plurality of target material plates for producing a radionuclide that are lined up in an overlapped manner, configured to produce the radionuclide when a particle beam is irradiated on the target material plates,

the plurality of target material plates being grouped into a front plate group composed of a part of the target material plates positioned to the front side the particle beam comes in, and a rear plate group composed of the residual part of the target material plates positioned to the rear side that is opposite to the front side, and

the diameter or average thickness of the target material plates composing the front plate group being smaller than the diameter or average thickness of the target material plates composing the rear plate group.

(2) The target device according to (1),

wherein the average thickness of the target material plates that configure the front plate group is smaller than the average thickness of the target material plates that configure the rear plate group,

the front plate group is composed of the target material plates that have the thickness smaller than the average thickness of all of the target material plates,

the rear plate group is composed of the target material plates that have the thickness not smaller than the average thickness of all of the target material plates, and

the number of the target material plates that configure the front plate group is smaller than the number of the target material plates that configure the rear plate group.

(3) The target device according to (1) or (2), further including a holding frame that holds the target material plates while keeping a space between adjacent target material plates.

(4) The target device according to (3),

wherein the ratio of the width of space between one target material plate and the neighboring target material plate that configure the front plate group, relative to the thickness of such one target material, is larger than the ratio regarding one target material plate that configure the rear plate group.

(5) The target device according to any one of (1) to (4),

wherein the plurality of target material plates are arranged so that the thickness thereof increases monotonously in the direction from the front plate group towards the rear plate group.

(6) The target device according to any one of (1) to (4),

wherein the plurality of target material plates contained in the front plate group are arranged so that, when viewed in the direction from the front side towards the rear side, the thickness once decreases and then increases.

(7) The target device according to any one of (1) to (6),

wherein the target material plates that configure the front plate group have the diameters smaller than the diameters of the target material plates that configure the rear plate group, and

the forefront target material plate in the front plate group has the diameter smaller than the diameter of the target material plate largest of all.

(8) The target device according to (7),

wherein at least a part of the plurality of target material plates that configure the front plate group are arranged so that the diameter thereof increases in the direction from the front side towards the rear side, and

at least a part of the plurality of target material plates that configure the rear plate group are arranged so that the diameter thereof decreases in the direction from the front side towards the rear side.

(9) The target device according to any one of (1) to (8),

wherein each of the target material plate that configures the front plate group has a thickness of 0.2 mm or larger and 10 mm or smaller.

(10) The target device according to any one of (1) to (9),

wherein all of the target material plates that configure the front plate group and the rear plate group have diameters of 10 mm or larger and 50 mm or smaller.

(11) A radionuclide producing apparatus that includes:

the target device described in any one of (1) to (10);

a particle accelerator that produces the particle beam; and

an extraction unit that extracts, from the target device, the radionuclide produced when the particle beam is irradiated on the target material plates.

(12) A method of producing a radionuclide by irradiating a target material plate with a particle beam, a plurality of the target material plates being lined up in an overlapped manner, while keeping a space between adjacent target material plates so as to allow a cooling medium to flow through the space during irradiation of the target material plates with the particle beam, the plurality of target material plates being grouped into a front plate group composed of a part of the target material plates positioned to the front side the particle beam comes in, and a rear plate group composed of the residual part of the target material plates positioned to the rear side that is opposite to the front side, and the ratio of the width of space between one target material plate and the neighboring target material plate that belong to the front plate group, relative to the thickness of such one target material, is larger than the ratio regarding one target material plate that belongs to the rear plate group.

(13) A method of producing a radionuclide by irradiating a target material plate with a particle beam, a plurality of the target material plates being lined up in an overlapped manner, while keeping a space between every adjacent target material plates so as to allow a cooling medium to flow through the space during irradiation of the target material plates with the particle beam, at least a part of the target material plates being arranged so that the diameter thereof increases in the direction from the front side towards the rear side, conforming to a distribution profile of bremsstrahlung photons that is produced from the target material plates irradiated by the particle beam.

(14) The method of producing a radionuclide according to (13), wherein the distribution profile of bremsstrahlung photons is widened, on the front side thereof the particle beam comes in, in the direction from the front side towards the rear side, and the plurality of the target material plates positioned to the front side the particle beam comes in are arranged so that the diameter thereof increases in the direction from the front side towards the rear side.

(15) The method of producing a radionuclide according to (14), wherein the distribution profile of bremsstrahlung photons has a spindle shape that is mostly widened at a position closer to the front side, and at least a part of the target material plates are arranged so that the diameter thereof increases once and then decreases.

What is claimed is:

1. A target device comprising a plurality of target material plates for producing a radionuclide that are lined up in an overlapped manner, configured to produce the radionuclide when a particle beam is irradiated on the target material plates,
the plurality of target material plates being grouped into a front plate group composed of a part of the target material plates positioned to the front side the particle beam comes in, and a rear plate group composed of the residual part of the target material plates positioned to the rear side that is opposite to the front side, and
the diameter or average thickness of the target material plates composing the front plate group being smaller than the diameter or average thickness of the target material plates composing the rear plate group.

2. The target device according to claim 1,
wherein the average thickness of the target material plates that configure the front plate group is smaller than the average thickness of the target material plates that configure the rear plate group,
the front plate group is composed of the target material plates that have the thickness smaller than the average thickness of all of the target material plates,
the rear plate group is composed of the target material plates that have the thickness not smaller than the average thickness of all of the target material plates, and
the number of the target material plates that configure the front plate group is smaller than the number of the target material plates that configure the rear plate group.

3. The target device according to claim 1, further comprising a holding frame that holds the target material plates while keeping a space between adjacent target material plates.

4. The target device according to claim 3,
wherein the ratio of the width of space between one target material plate and the neighboring target material plate that configure the front plate group, relative to the thickness of such one target material, is larger than the ratio regarding one target material plate that configure the rear plate group.

5. The target device according to claim 1,
wherein the plurality of target material plates are arranged so that the thickness thereof increases monotonously in the direction from the front plate group towards the rear plate group.

6. The target device according to claim 1,
wherein the plurality of target material plates contained in the front plate group are arranged so that, when viewed in the direction from the front side towards the rear side, the thickness once decreases and then increases.

7. The target device according to claim 1,
wherein the target material plates that configure the front plate group have the diameters smaller than the diameters of the target material plates that configure the rear plate group, and
the forefront target material plate in the front plate group has the diameter smaller than the diameter of the target material plate largest of all.

8. The target device according to claim 7,
wherein at least a part of the plurality of target material plates that configure the front plate group are arranged so that the diameter thereof increases in the direction from the front side towards the rear side, and
at least a part of the plurality of target material plates that configure the rear plate group are arranged so that the diameter thereof decreases in the direction from the front side towards the rear side.

9. The target device according to claim 1,
wherein each of the target material plate that configures the front plate group has a thickness of 0.2 mm or larger and 10 mm or smaller.

10. The target device according to claim 1,
wherein all of the target material plates that configure the front plate group and the rear plate group have diameters of 10 mm or larger and 50 mm or smaller.

11. A radionuclide producing apparatus comprising:
the target device described in claim 1;
a particle accelerator that produces the particle beam; and
an extraction unit that extracts, from the target device, the radionuclide produced when the particle beam is irradiated on the target material plates.

12. A method of producing a radionuclide by irradiating a target material plate with a particle beam, a plurality of the target material plates being lined up in an overlapped manner, while keeping a space between adjacent target material plates so as to allow a cooling medium to flow through the space during irradiation of the target material plates with the particle beam, the plurality of target material plates being grouped into a front plate group composed of a part of the target material plates positioned to the front side the particle beam comes in, and a rear plate group composed of the residual part of the target material plates positioned to the rear side that is opposite to the front side, and the ratio of the width of space between one target material plate and the neighboring target material plate that belong to the front plate group, relative to the thickness of such one target material, is larger than the ratio regarding one target material plate that belongs to the rear plate group.

13. A method of producing a radionuclide by irradiating a target material plate with a particle beam, a plurality of the target material plates being lined up in an overlapped manner, while keeping a space between every adjacent target material plates so as to allow a cooling medium to flow through the space during irradiation of the target material plates with the particle beam, at least a part of the target material plates being arranged so that the diameter thereof increases in the direction from the front side towards the rear side, conforming to a distribution profile of bremsstrahlung photons that is produced from the target material plates irradiated by the particle beam.

14. The method of producing a radionuclide according to claim 13, wherein the distribution profile of bremsstrahlung photons is widened, on the front side thereof the particle beam comes in, in the direction from the front side towards the rear side, and the plurality of the target material plates positioned to the front side the particle beam comes in are arranged so that the diameter thereof increases in the direction from the front side towards the rear side.

15. The method of producing a radionuclide according to claim 14, wherein the distribution profile of bremsstrahlung photons has a spindle shape that is mostly widened at a position closer to the front side, and at least a part of the target material plates are arranged so that the diameter thereof increases once and then decreases.
